(19) United States
(12) Patent Application Publication
(10) Pub. No.: US 2010/0037231 A1
(43) Pub. Date: Feb. 11, 2010

(54) METHOD FOR READING/WRITING DATA IN A MULTITHREAD SYSTEM

(76) Inventors: Chih-Wei CHEN, Taipei City (TW); Hsiao-Fen LU, Taipei City (TW)

Correspondence Address: BRIAN M. MCINNIS, 12th Floor, Ruttonjee House, 11 Duddell Street, Hong Kong, HK

(21) Appl. No.: 12/252,625

(22) Filed: Oct. 16, 2008

(30) Foreign Application Priority Data
Aug. 6, 2008 (TW) 97129907

(51) Int. Cl. G06F 9/50

(52) U.S. Cl. 718/104

(57) ABSTRACT

A method for reading/writing data in a multithread system is disclosed. The method includes providing an unprocessed command number of a read/write command waiting queue; providing an expectation read/write thread number according to the unprocessed command number; comparing the expectation read/write thread number with a present read/write thread number; and equalizing the expectation read/write thread number and the present read/write thread number by newly-generating or deleting a read/write thread.

### RELATED APPLICATIONS

This application claims priority to Taiwan Application Serial Number 97129907, filed Aug. 6, 2008, which is herein incorporated by reference.

### BACKGROUND

1. Field of Invention

The present invention relates to a method for reading/writing data in a disk. More particularly, the present invention relates to a method for reading/writing data in a multithread system.

2. Description of Related Art

A multithread system has high processing efficiency because a plurality of threads process commands under different categories. Each category has at least one thread to process the respective commands, and the threads are sent to the processor to process the commands thereof. The operating system could switch the threads at the processor in sequence in a short time, and the processor could skip some threads under a long-waiting event. The processor could process plural commands in a short time by switching the threads to improve the processing efficiency of the operating system.

The multithread is used to read/write data in the disk. The read/write commands can be allocated to plural threads in order to improve the read/write efficiency. However, the number of the read/write threads for processing the read/write commands is fixed, some of the read/write threads might be idling when there are not many read/write commands. The idle read/write threads belong to the multithread system when the operating system switches the threads. Thus the processing efficiency of the multithread system is slowed down because of the switching through the idle read/write threads.

For the forgoing reasons, there is a need to solve low processing efficiency caused by the idle read/write threads when the read/write commands are operating in a multithread system.

### SUMMARY

The present invention is directed to read/write data in a multithread system, that satisfies this need to prevent the idle read/write threads from slowing down the system efficiency.

The invention provides an embodiment of a method for reading/writing data in a multithread system, the method includes receiving a read/write command; sending the read/write command to a read/write command waiting queue; providing an unprocessed command number of the read/write command waiting queue; providing a plurality of read/write threads according to the unprocessed command number; and allocating the read/write command to one of the read/write threads.

The invention also provides another embodiment of the method for reading/writing data in a multithread system, the method includes providing an unprocessed command number of a read/write command waiting queue; providing an expectation read/write thread number according to the unprocessed command number; comparing the expectation read/write thread number with a present read/write thread number; and equalizing the expectation read/write thread number and the present read/write thread number by newly-generating or deleting a read/write thread.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart diagram of an embodiment of the method for reading/writing data in a multithread system of the invention; and

FIG. 2 is a flow chart diagram of another embodiment of the method for reading/writing data in a multithread system of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides a method for reading/writing data in a multithread system to prevent system efficiency degradation caused by switching through too many idle read/write threads. The read/write threads in this invention are dynamically generated or deleted to fit different amount of the read/write commands, thus the number of idle read/write threads can be minimized and the processing efficiency of the processor in the multithread system would not be slowdown.

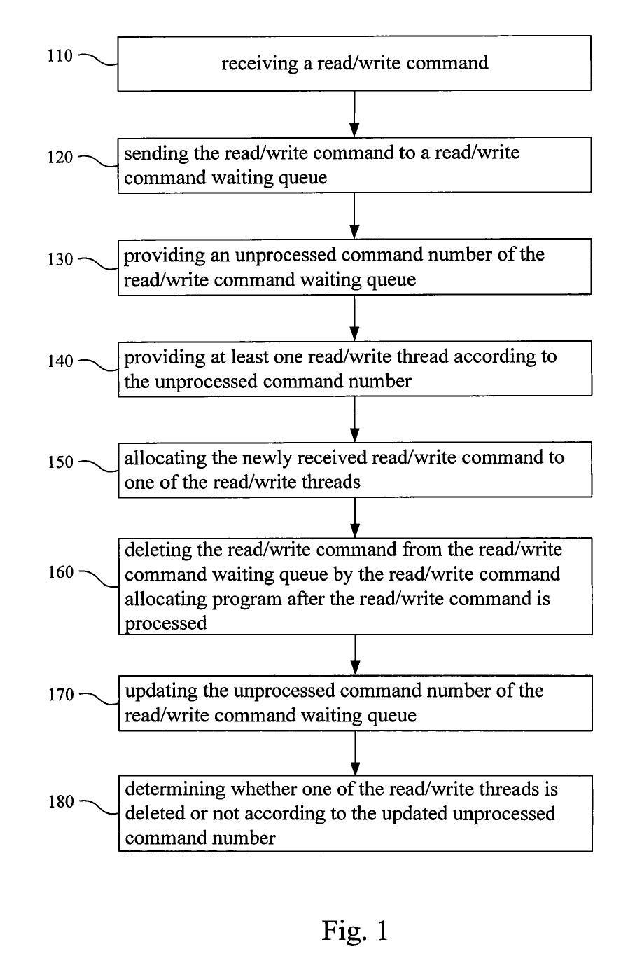

Refer to FIG. 1. FIG. 1 illustrates a flow chart diagram of an embodiment of the method for reading/writing data in a multithread system of the invention. The operating system has a read/write command allocating program to allocate the received read/write commands to the read/write threads. In step 110, a read/write command is received at the read/write command allocating program, and the read/write command allocating program sends the read/write command to a read/write command waiting queue in step 120. Then, step 130 provides an unprocessed command number of the read/write command waiting queue. Step 130 further includes updating the unprocessed command number of the read/write command waiting queue when the received read/write command is sent to the read/write command waiting queue. The unprocessed command number of the read/write command waiting queue includes the allocated read/write commands and the unallocated read/write command. The allocated read/write commands include wait-to-process commands and processing commands. The unallocated read/write command is the newly received read/write command, which has not been allocated.

In step 140, at least one read/write thread is provided. The read/write command allocating program can define a maximum processing number of each read/write thread to prevent too many read/write commands sending to one read/write thread. The number of read//write threads is according to the unprocessed command number of the read/write command waiting queue and the maximum processing number defined by the read/write command allocating program. In step 150, the newly received read/write command is allocated to one of the read/write threads.

In step 160, the read/write command is deleted from the read/write command waiting queue by the read/write command allocating program after the read/write command is processed. Then the unprocessed command number of the read/write command waiting queue is updated in step 170. Step 180 determines whether one of the read/write threads is deleted or not according to the updated unprocessed command number. Namely, the read/write thread more than the requirement can be deleted in step 180 to prevent that the system efficiency might be slowdown by too many idle read/write threads.

The number of the read/write threads provided in step 140 can be determined by any reasonable rule. For example, the number of the read/write threads can be decided by carrying the value of the unprocessed command number divided by the maximum processing number to the integer place, or number of the read/write threads can equals to the integer part of (unprocessed command number−1)/maximum processing number plus one.

The number of the read/write threads provided in this embodiment is related to the present unprocessed command number and can be altered dynamically. The number of the read/write threads can be reduced when there are less read/write commands. The number of the read/write threads can be increased when there are too many read/write commands.

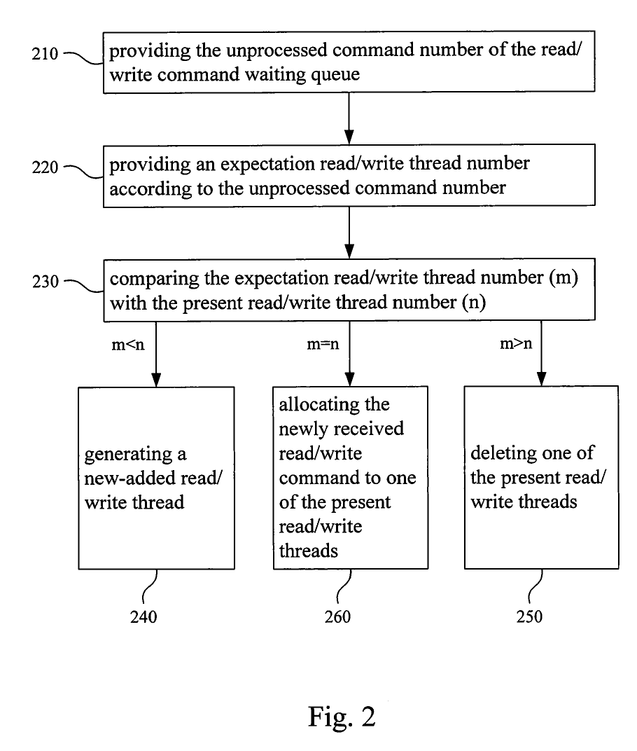

Refer to FIG. 2. FIG. 2 illustrates a flow chart diagram of another embodiment of the method for reading/writing data in a multithread system. The invention has the read/write command allocating program to record the unprocessed command number of the read/write command waiting queue. The unprocessed command number includes the wait-to-process commands, the processing commands, and the newly received read/write command. The unprocessed command number of the read/write command waiting queue is provided by the read/write command allocating program in step 210. The unprocessed command number is changed when a read/write command is received or processed.

Step 220 provides an expectation read/write thread number according to the unprocessed command number. Step 230 compares the expectation read/write thread number (m) with the present read/write thread number (n) to determine if there is a need to delete one of the present read/write threads or to generate a new-added read/write thread to equalize the expectation read/write thread number (m) and the present read/write thread number (n).

If the expectation read/write thread number (m) is equal to the present read/write thread number (n), step 260 is allocating the newly received read/write command to one of the present read/write threads.

If the read/write command is received and increases the unprocessed command number in step 210, that may cause that the expectation read/write thread number (m) is larger than the present read/write thread number (n) in step 230. Then, the new-added read/write thread would be generated in step 240, and the received read/write command can be send to the new-added read/write thread,

If the read/write command is processed and reduces the unprocessed command number in step 210, that may cause that the expectation read/write thread number (m) is smaller than the present read/write thread number (n) in step 230. Then, one of the present read/write threads would be deleted in step 250. More particularly, the read/write command allocating program would send a finish signal to the one of the read/write threads to delete the read/write thread when the read/write thread has processed all the read/write commands within. The system efficiency of the multithread system may not be slowed down when deleting the idle read/write thread is deleted in this embodiment.

The number of the read/write threads can be dynamically altered relating to the present read/write commands by deleting the idle read/write thread when there are less read/write commands or generating the new-added read/write thread when there are too many read/write commands. The number of the idle read/write threads can be reduced and the system efficiency of the operating system would not be slowdown by too many idle threads.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for reading/writing data in a multithread system comprising:
receiving a read/write command;
sending the read/write command to a read/write command waiting queue;
providing an unprocessed command number of the read/write command waiting queue;
providing a plurality of read/write threads according to the unprocessed command number; and
allocating the read/write command to one of the read/write threads.

2. The method for reading/writing data in a multithread system of claim 1, further comprising deleting the read/write command from the read/write command waiting queue after the read/write command is processed.

3. The method for reading/writing data in a multithread system of claim 2, further comprising updating the unprocessed command number of the read/write command waiting queue.

4. The method for reading/writing data in a multithread system of claim 3, further comprising determining whether one of the read/write threads is deleted or not according to the updated unprocessed command number.

5. The method for reading/writing data in a multithread system of claim 1, further comprising defining a maximum processing number of each read/write thread.

6. The method for reading/writing data in a multithread system of claim 5, wherein the number of the plurality of read/write threads is decided according to the unprocessed command number and the maximum processing number.

7. The method for reading/writing data in a multithread system of claim 6, wherein providing the read/write threads further comprising generating a new-added read/write thread according to the unprocessed command number.

8. The method for reading/writing data in a multithread system of claim 7, wherein the read/write command is allocated to the new-added read/write thread.

9. A method for reading/writing data in a multithread system comprising:
providing an unprocessed command number of a read/write command waiting queue;
providing an expectation read/write thread number according to the unprocessed command number;
comparing the expectation read/write thread number with a present read/write thread number; and
equalizing the expectation read/write thread number and the present read/write thread number by new-adding or deleting a read/write thread.

10. The method for reading/writing data in a multithread system of claim 9, further comprising defining a maximum processing number of each read/write thread, wherein the expectation read/write thread number is determined by the unprocessed command number and the maximum processing number.

11. The method for reading/writing data in a multithread system of claim 9, further comprising updating the unprocessed command number of the read/write command waiting queue when a read/write command is processed.

12. The method for reading/writing data in a multithread system of claim 9, further comprising updating the unprocessed command number when a read/write command is received and sent to the read/write command waiting queue.

13. The method for reading/writing data in a multithread system of claim 9, wherein the unprocessed command number comprises the number of allocated read/write commands and an unallocated read/write command.
